(19) United States
(12) Patent Application Publication
(10) Pub. No.: US 2007/0151608 A1
(43) Pub. Date: Jul. 5, 2007

(54) Double-walled safety tank including a valve

(76) Inventor: Britta Daume, Hannover (DE)

Correspondence Address: SHLESINGER, ARKWRIGHT & GARVEY LLP, 1420 KING STREET, SUITE 600, ALEXANDRIA, VA, 22314, US

(21) Appl. No.: 11/646,608

(22) Filed: Dec. 28, 2006

Related U.S. Application Data
(63) Continuation of application No. PCT/EP05/05448, filed on May 19, 2005.

(30) Foreign Application Priority Data
Jun. 29, 2004 (DE) 10 2004 031 574.4

(51) Int. Cl. F16K 37/00

(52) U.S. Cl. 137/557

(57) ABSTRACT

Valve includes a passage in which a valve seat and a movable sealing element are provided for blocking the passage. The valve is embodied in a double-walled manner, such as a housing, so as to be provided with an intermediate space. The valve includes a function monitoring device. A safety tank includes a double-walled container and at least one discharge port to which a valve is connected.

### CROSS-REFERENCE TO RELATED APPLICATIONS

This application is a continuation of application no. PCT/EP2005/005448, filed May 19, 2005, which claims the priority of German application no. 10 2004 031 574.4, filed 29 Jun. 2004, and each of which is incorporated herein by reference.

### FIELD OF THE INVENTION

The invention relates to a valve including a passage in which a valve seat and a moveable sealing element are provided for blocking the passage, as well as a double-walled safety tank including a double-walled container and at least one discharge port to which a valve is connected.

### BACKGROUND OF THE INVENTION

Such double-walled safety tanks are used to store and transport liquids, in particular hazardous liquids. The container of the safety tank must be double-walled and include an intermediate space. The valve that is connected to the discharge port of the container also must be double-walled and must have an intermediate space with the intermediate space of the safety tank being interconnected with the intermediate space of the valve so that the safety tank includes a common intermediate space with the valve that is connected to the discharge port.

To reliably prevent hazardous liquid from exiting, EP 1 179 505 B1 discloses a known double-walled container with a leak detector device in which a second valve is connected to a first valve that is connected to a discharge port of a double-walled container, with the second valve also being double-walled. Here, the intermediate spaces of the container, of the first and the second valve form one common intermediate space. The common monitoring space is monitored by way of a pressure leakage indicator that transmits a signal to a corresponding signaling unit when a leak is detected. This device increases the level of safety since it is not possible that both valves and the internal or external walls of the tank and the double-walled line of the discharge port all fail simultaneously.

However, the design of the double-walled container with the leak detection device according to EP 1 179 505 B1 is complicated due to the use of two valves with both valves having to be controlled simultaneously.

### OBJECTS AND SUMMARY OF THE INVENTION

An object of the invention is to provide a safety tank which overcomes the drawbacks of the prior art.

Another object of the invention is to provide a valve which overcomes the drawbacks of the prior art.

A further object of the invention is to provide a safety tank with a simplified construction.

The object of the invention is achieved by providing a safety tank which includes a double-walled container and at least one discharge port to which a valve having a passage in which a valve seat and a moveable sealing element for blocking the passage are provided, and in which the valve is double-walled and includes an intermediate space, and a monitoring device for monitoring the function is likewise provided.

The object of the invention is achieved by providing a valve which includes a passage in which a valve seat and a moveable sealing element for blocking the passage are provided and in which the valve is double-walled and includes an intermediate space, and there is a monitoring device for monitoring the function.

The function monitoring device allows for monitoring the operability of the valve and the tightness of the double-walled container of the safety tank for leaks. Thus, the use of two double-walled valves provided in series is not required, which reduces cost. The function monitoring device is such that they are provided on the sealing element or the valve seat and allow for at least monitoring the operability of the valve for tightness while the valve is closed. Alternatively, the function monitoring device can be equipped to measure the differential pressure with which the pressure difference can be measured that decreases across one or a plurality of throttle locations or the sealing element/valve seat.

The valve can be provided in a rigid manner, e.g. by welding, to the discharge port of a container of a safety tank or to one end of a double-walled line. However, preferably the valve is provided on the connection on a double-walled container with the intermediate space of the valve being connected to the intermediate space of the double-walled container by way of a suitable connection so that they form one common intermediate space. Such a connection can be achieved by way of flanges including passages that provide a connection between the individual intermediate spaces.

In a preferred embodiment, the function monitoring device includes at least one measuring chamber on the sealing element and/or on the valve seat. This arrangement of a measuring chamber allows for a function test for tightness of the closed valve when the valve is closed and the sealing element rests on the valve seat.

Preferably, the measuring chamber is a channel that is provided on the inside of the sealing element or the outside of the valve seat and runs along the circumference.

If the measuring chamber is provided on the outside of the valve seat, the valve, in a preferred embodiment, includes a passage that connects the at least one measuring chamber with the outside of the housing. The pressure itself can be recorded at the housing side end of the passage or it can be transformed into an electric variable by way of transducers, such as pressure sensors.

If, however, the measuring chamber is provided on the inside of the sealing element, the sealing element includes a passage that runs continuously through the valve spindle. On one opening of the valve spindle or at its upper end a transducer can be connected for converting the measured pressure into an electric variable.

In another embodiment, a transducer is provided in the at least one measuring chamber itself. In this embodiment, it is not necessary to provide a passage. Instead, the measured pressure can be transformed into an electric variable in the measuring chamber and this electric variable can be transmitted to other devices by way of corresponding lines.

Preferably, the sealing element is double-walled. This double-walled configuration of the sealing element ensures that the sealing element of the valve itself is monitored for leaks or leakiness that could be the result of a break, for example.

In a preferred embodiment, the double-walled sealing element has a monitoring space that includes a connection to the measuring chamber in at least one position of the double-walled sealing element. For example, with the valve being closed, and with the double-walled sealing element resting on the valve seat, the monitoring space can be provided such that it includes a connection to the measuring chamber of the valve seat. Thus, the monitoring space of the double-walled sealing body can be monitored without any additional elements by using a transducer in the measuring chamber or by measuring the pressure at the end of the passage.

Preferably, the valve includes a monitoring device that records the measured pressure. The monitoring device can include a pressure sensor and generates an alarm signal when a leak occurs.

In a preferred embodiment the monitoring device has an interface for exchanging data and/or commands with computer networks so that additional data and a generated alarm signal can be transmitted to the computer network, for example for monitoring equipment.

The valve can include a manual, pneumatic, hydraulic, electric or electromagnetic valve drive with which the sealing element can be opened or closed.

However, preferably the valve is a three-position control valve. With such a valve, it is possible to put the sealing element into a partially opened position. Such three-position control valves allow for controlling material streams with a high level of inertia whereby the partially open position is triggered prior to closing a discharge port of a tank or a line by reaching the closed position of the sealing element on the valve seat. In this position the material stream is throttled prior to closing the valve and thus the mechanical stress for the line due to liquid impact is reduced. Furthermore, the use of three-position control valves allows for an exact proportioning of the released liquid amount since prior positioning of the sealing element to a half-open position allows for quick closing without delay once the preset amount is reached.

In a preferred embodiment, the lift of the sealing element in a partially opened position can be 0 to 100%, in particular 0 to 15% of the overall lift.

And, the valve in a preferred manner is configured so that the lift in the partially open position can be adjusted in this range.

In the following paragraphs, the invention is described in connection with the drawings.

### BRIEF DESCRIPTION OF THE DRAWINGS

FIG. 1 is a section through an inventive valve with a three-position valve drive,

FIG. 2 is a section through an inventive valve with a two-position valve drive,

FIG. 3 is an enlarged section of the valve of FIG. 1 in a closed state,

FIG. 4 is an enlarged section of the valve of FIG. 1 in a half open state,

FIG. 5 is an enlarged section of FIG. 1 in an open state, and

FIG. 6 is an enlarged section of a valve with a double-walled sealing element.

### DETAILED DESCRIPTION OF THE INVENTION

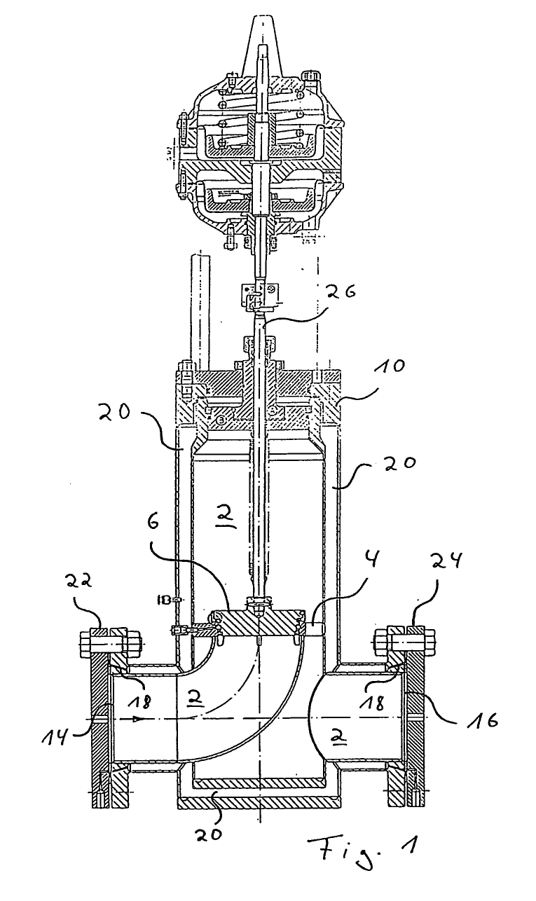

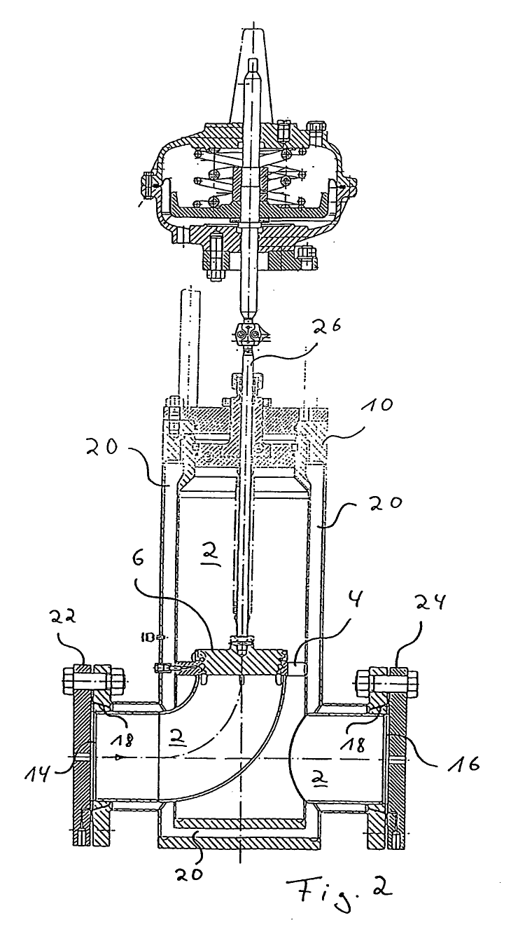

Reference is made to FIGS. 1 and 2.

A valve is shown with an entry 14 on the entry side and an exit 16 on the exit side that are connected by way of a passage 2 in which a valve seat 4 and a moveable sealing element 6 are provided for blocking the passage 2.

With the entry side entry 14 of the valve the valve can be connected to a discharge of a double-walled container of a safety tank. A housing 10 of the valve is double-walled and has an intermediate space 20 with connecting flanges 22, 24 being provided on the entry side entry 14 and the exit side exit 16. The flanges 22, 24 include passages 18 with which the intermediate space 20 of the valve can be connected to the intermediate space of a double-walled container of a safety tank so that a common intermediate space is formed. This common intermediate space can be monitored with a pressure sensor (not shown), for example.

The sealing element 6 is connected to a valve drive by way of a valve spindle 26 with the drive, as shown in FIG. 1, allowing for the sealing element 6 to be adjusted into three different positions while the valve drive according to FIG. 2 only allows for adjusting the sealing element 6 between an open or a closed position. The valve drive according to FIGS. 1 and 2 is pneumatic; however, it is possible to also use a manual drive, a hydraulic drive, electric motors, or electromagnets.

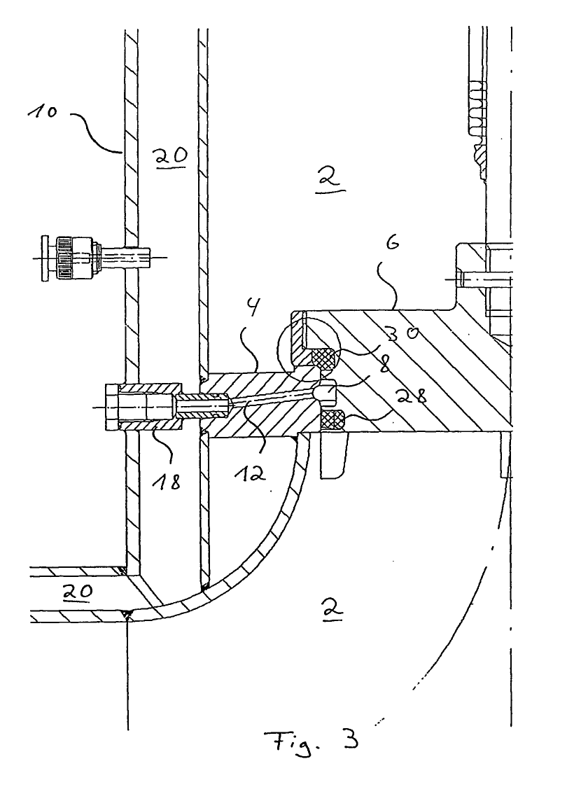

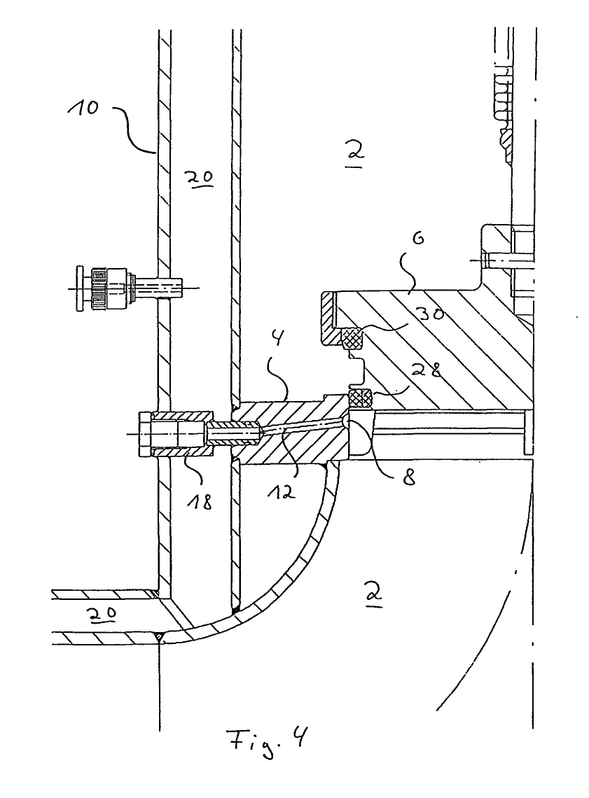

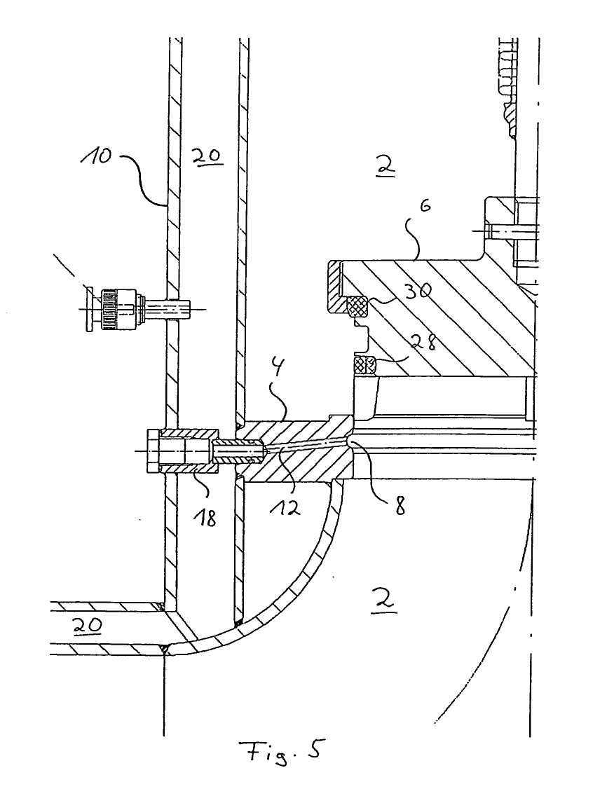

Reference is now made to FIGS. 3 through 5.

The function monitoring device includes a measuring chamber 8 in the form of a channel that runs along the inside of the valve seat 4. A passage 12 runs through the valve seat 4 that connects the measuring chamber 8, which is a circumferential channel, with the outside of the housing 10 of the valve with a pressure-tight passage 18 being provided through the intermediate space 20. This means the pressure can be measured on the outside of the housing.

The sealing element 6 has a first seal 28 and a second seal 30 with both being inserted in the circumferential channels of the sealing element 6.

In a closed position the tightness of first seal 28 can be measured by measuring the pressure in measuring chamber 8, while in a partially open position of sealing element 6 the tightness of second seal 30 can be checked, so that by providing one single measuring chamber with a transducer, it is possible to monitor and control the operability of a shut-off device with a three-position control valve.

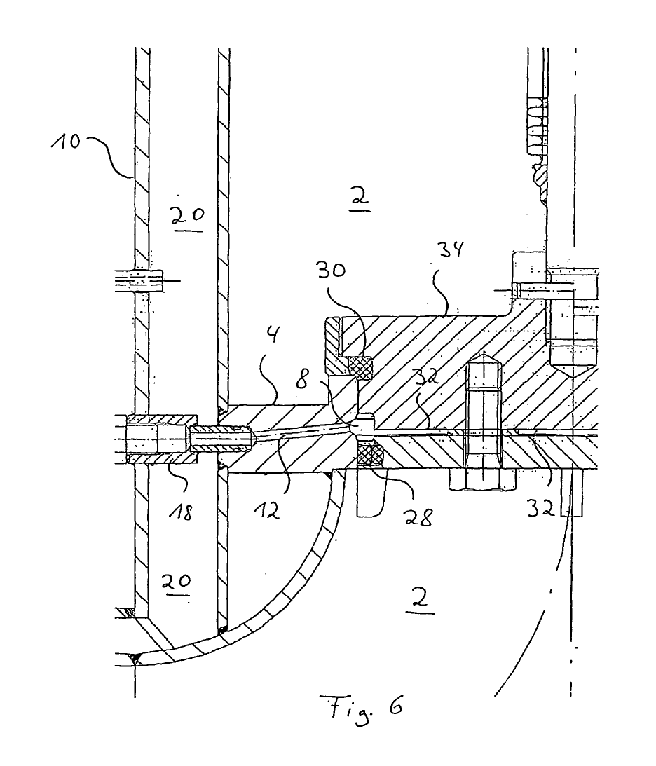

Reference is now made to FIG. 6.

In a valve according to FIG. 6 the function monitoring device, apart from measuring chamber 8 on the inside of the valve and passage 12 that provides a connection between the measuring chamber 8 and the outside of the housing 10 and the valve, includes a monitoring space 32 that is provided in a double-walled sealing element 34.

This means that when double-walled sealing element 34 is closed, the operability of the seal 28 can be monitored and leaks in the double-walled sealing element 34 can be detected. This means that it is possible to detect leakiness and leaks with the help of a double-walled sealing element 34 including a monitoring space 32 in cases in which the sealing element 34 of the valve is damaged due to a break or any kind of other leak, for example.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Valve, comprising:
a) a passage;
b) a valve seat and a moveable sealing element being provided in the passage for blocking the passage;
c) a double-walled housing defining an intermediate space; and
d) a function monitoring device being provided, the function monitoring device being configured for monitoring the function of the valve.

2. Valve according to claim 1, wherein:
a) the valve is configured so that it is connectable to a discharge port of a double-walled container.

3. Valve according to claim 2, wherein:
a) the function monitoring device includes a measuring chamber provided on the sealing element on the valve seat.

4. Valve according to claim 3, wherein:
a) the measuring chamber is a channel.

5. Valve according to claim 4, wherein:
a) a passage is provided which connects the measuring chamber with an outside of the housing.

6. Valve according to claim 4, wherein:
a) a transducer is provided in the measuring chamber.

7. Valve according to claim 1, wherein:
a) the sealing element is double-walled.

8. Valve according to claim 7, wherein:
a) the double-walled sealing element includes a monitoring space that has a connection to the measuring chamber in at least one position.

9. Valve according to claim 1, wherein:
a) a monitoring device configured to record a measured pressure is provided.

10. Valve according to claim 9, wherein:
a) the monitoring device includes an interface to exchange one of data and commands with a computer network.

11. Valve according to claim 1, wherein:
a) a three-position control valve is provided.

12. Valve according to claim 11, wherein:
a) a lift of the sealing element is 0 to 100% in the partially open position.

13. Valve according to claim 12, wherein:
a) the lift of the sealing element can be adjusted in the partially opened position.

14. Valve according to claim 12, wherein:
a) the lift of the sealing element is 0 to 15% in the partially open position.

15. Valve according to claim 1, wherein:
a) the valve is configured so that it is connectable to a discharge port of a double-walled line.

16. Valve according to claim 1, wherein:
a) the function monitoring device includes at least one measuring chamber provided on the valve seat.

17. Safety tank with a double-walled container and at least one discharge port, wherein:
a) the valve according to claim 1 is attached to the discharge port.
